(19) United States
(12) Patent Application Publication
(10) Pub. No.: US 2017/0286995 A1
(43) Pub. Date: Oct. 5, 2017

(54) Computing A Score For Opportunities In A Placement System

(71) Applicant: BRANDED ENTERTAINMENT NETWORK, INC., SHERMAN OAKS, CA (US)

(72) Inventors: Gary Shenk, Bainbridge Island, WA (US); Greg David Isaacs, Los Angeles, CA (US); Barrett Carlton Morse, Los Angeles, CA (US); Alexander Charles McFadyen, London (GB); Zachary Alden Baker, Los Angeles, CA (US); Nick Joseph Johnson, Sherman Oaks, CA (US); Matt James McElroy, Seattle, CA (US)

(73) Assignee: BRANDED ENTERTAINMENT NETWORK, INC., SHERMAN OAKS, CA (US)

(21) Appl. No.: 15/622,980

(22) Filed: Jun. 14, 2017

Related U.S. Application Data
(63) Continuation-in-part of application No. 14/136,906, filed on Dec. 20, 2013.
(60) Provisional application No. 62/350,022, filed on Jun. 14, 2016.
(60) Provisional application No. 61/746,976, filed on Dec. 28, 2012.

(51) Int. Cl. G06Q 30/02; G06F 17/30

(52) U.S. Cl. CPC G06Q 30/0246; G06F 17/30864; G06F 17/30312; G06Q 30/0249; G06Q 30/0269; G06Q 50/01

(57) ABSTRACT

Various embodiments are directed towards a product placement system that enable a media buyer to define a persona, which is a visual representation of a fictitious individual that represents a target audience for a placement campaign, and a placement is a visible display of a product that is placed in a media vehicle. The invention stores the persona, which represents a target audience, ingests data that about placement opportunities, identifying one or more opportunities whose characteristics overlap the characteristics of the target audience, calculates an audience score, identifies one or more opportunities with which the target audience engages using social media, and calculates an engagement score that measures the relative level of engagement with the identified opportunities by the target audience.

### CROSS-REFERENCE TO RELATED APPLICATIONS

This application claims the benefit of U.S. Provisional Application No. 62/350,022, filed Jun. 14, 2016, which is incorporated herein by reference in its entirety and is a continuation-in-part of U.S. patent application Ser. No. 14/136,906 filed on Dec. 20, 2013, which is incorporated herein by reference in its entirety, and which claims the benefit of U.S. Provisional Application No. 61/746,976 filed on Dec. 28, 2012.

### TECHNICAL FIELD

Various embodiments generally relate to a system for placing product advertising within media and computing a score that assesses the fit or match between a target audience and a plurality of content opportunities based on aggregated audience data.

### BACKGROUND

Product placement refers to the placement of product and brand advertising integrated within media such as movies, television programs, social media, songs, Web photos and videos and the like such that the advertising is integrated within the media. Thus, unlike traditional advertising, product placements do not disrupt the continuity of the media. Examples include an actor holding a specific beverage product in a movie where the beverage product's label is prominently featured, an actor driving a specific type of car within a television program, a song that mentions a specific product, or a photo of a celebrity published on a Web page in which the celebrity is wearing a specific brand of clothing. Product placement is a form of advertising but is different from conventional advertising and is not addressed by existing computer-based advertising systems, tools and platforms.

Typically, an advertiser, or as referred to herein a “brand” creates a brand brief that defines the market for a product or service to be advertised as part of an advertising campaign. The brand brief defines the characteristics of a target audience, i.e. the demographic, psychographic and behavioral characteristics of potential buyers of a product or service. A brand brief typically includes “personas”, i.e. hypothetical individuals that represent target audiences, or segments of the potential audience. Multiple personas may be used to define the target audience.

Prior art advertising systems do not typically provide tools or facilities to ingest and use persona information as provided in brand briefs. Therefore, it would be advantageous to provide a system that enables a user or buyer that defines a media plan for an advertising campaign to work directly with personas supplied by a brand.

With the proliferation of media, e.g. TV, cable, Web, social media, etc., there are a large number of potential opportunities for placements. Thus, it would be advantageous to be able to score or rank an opportunity as to how it coincides or fits with a target audience defined by a media buyer. Such a “fit” metric could be used to order search results, rank selections of opportunities for a media buyer, determine prices, and provide an easy to understand metric for review by the buyer, etc. Therefore, it would be advantageous to be able to automatically determine the fit between a particular opportunity and the target audience, as represented by personas defined by a brand.

Thus, it is with respect to these considerations and others that the present invention has been made.

### SUMMARY OF THE DESCRIPTION

Various embodiments are directed towards a product placement system that enable a media buyer to interactively specify a placement campaign for the integration or placement of branded products within media such as movies, videos, songs, and celebrity photos and videos based on estimated prices for placements. The placement system ingests information about productions that represent potential opportunities for placements and stores the data in a data warehouse.

In certain embodiments, a buyer specifies a target audience using a visual persona that represents a variety of attributes, such as demographic details and psychographic details. Persona may be combined and weighted to represent a target audience or multiple target audiences. Further, the component attributes of a persona may be weighted.

A Fit metric is computed for opportunities. The “fit” metric may be used to order search results, rank selections of opportunities for a media buyer, determine prices, and provide an easy to understand metric for review by the buyer, and the like.

In certain embodiments, two scores are computed for each opportunity: an audience score that measures the overlap between the audience for an opportunity and the desired, or target, audience as defined by a brand using a brand persona; and an engagement score that measures the level of social engagement by an audience with the vehicle in which the opportunity is placed.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 is a generalized block diagram of a preferred embodiment of an online product placement system in which a product placement service enables a media buyer, or user to specify a media plan, and then searches for product placement opportunities that conform to the media plan.

FIG. 2A illustrates one embodiment of a user interface that enables a buyer to specify requirements for a product placement media plan.

FIG. 2B illustrates one embodiment of a user interface that enables a buyer to specify a channel mix for a product placement media plan and to interactively select and reject product placement opportunities provided by a product placement system.

FIG. 2C illustrates one embodiment of a user interface, referred to as a buyer interface, which summarizes the results of a single placement campaign based on a media plan.

FIG. 3A illustrates how personas are used in a media planning interface to define a target audience.

FIG. 3B illustrates an embodiment of a search results buyer interface.

FIG. 3C provides an embodiment of a buyer interface that enables the buyer to select personas, view characteristics of personas, create new personas and edit personas.

FIG. 3D is an embodiment of a buyer interface that enables a user to view and edit persona details.

FIG. 3E illustrates an additional example of a buyer interface that may be used to edit detailed characteristics for a persona.

FIG. 4A is a simplified block diagram of a content data system (CDS) that collects and ingest data from external data sources and incorporates internally generated data to create opportunity data objects that can be evaluated against target audiences.

FIG. 4B illustrates an embodiment of processes performed by a brand placement system.

FIGS. 5A-C provide an example visual depiction of the data included in an opportunity data object

FIG. 6A illustrates the relationship between a target audience defined for a brand and a content audience for an opportunity.

FIG. 6B presents a simplified example of scoring a target audience, as represented by a brand persona, relative to an audience for a vehicle or opportunity.

FIG. 7 is a flow diagram that illustrates a method that creates personas for use in persona based matching (PBM).

FIGS. 8A-C is overall method for discovering an opportunity and then calculating an audience sore, an engagement score, and a Fit metric between the opportunity and a target audience.

FIG. 9 is a system diagram that shows components of one exemplary environment in which the invention may be practiced.

FIG. 10 is block diagram of exemplary software modules of a product placement server.

### DETAILED DESCRIPTION

The invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods or devices. Accordingly, the present invention may take the form of an entirely hardware embodiment, an entirely software embodiment or an embodiment combining software and hardware aspects. The following detailed description is, therefore, not to be taken in a limiting sense.

As used herein the following terms have the meanings given below:

Impression—refers to a viewing or listening of a piece of media such as a movie, television program, social media, Web video, song, or photo by one person.

CPM—refers to a standard cost metric that means the price charged by a publisher for a conventional advertisement or placement in a piece of media for one thousand impressions or views.

Channel—as used herein refers to a category of media in which a product placement can be made. Channels include television, movies, music, social media, printed advertisements, Web video advertisement, Web image advertisements, and the like.

Media Vehicle or vehicle—refers to a specific piece of media such as a specific television program, film or movie, social media network such as FACEBOOK or INSTAGRAM, web advertisement, video, song or other piece of media in which a product placement may be made.

Vehicle power—refers to a rating of the intrinsic value of a particular vehicle piece of media to a media buyer, for example a TV program, a film, etc. This can be determined by factors such as the viewership of the vehicle, cast, director, buzz, etc. It may be noted that CPM for conventional advertising in television programs doesn't always correlate to the program's viewership. This may be due to the fact that some shows attract higher value demographics than others and hence receive a higher CPM even when it has a smaller audience. In one embodiment vehicle power is stated as a letter value, e.g. A, B, or C where A refers to vehicles that have more value, and are thus more costly to advertise in and C refers to vehicles that have less value and thus are less expensive to advertise in.

Branded product placement, product placement or placement—means the integration of a display, appearance, or mention of a product or brand within a vehicle. The media may be audio or visual, or both, such as within a music video. A placement is different than a conventional advertisement in that it is integrated with the media content, i.e. there is continuity between the media content of the vehicle and the placement. Thus, the storyline of the vehicle is not disrupted and the viewer does not perceive a placement as a separate advertisement. For example, a viewer can choose not to watch a commercial inserted into a television program and not miss the program content itself. Integration of a product placement into a vehicle means that if the viewer doesn't see the placement they miss viewing or listening to at least a portion of the vehicle content. The term product placement refers to advertisements for specific products as well as to more general advertisements for brands, e.g. when a company logo might appear rather than a specific product. Examples of placements include an actor in a movie driving a specific model of car during a chase scene, an actor holding a specific, easily recognizable beverage, in a movie, film, or photo, or a mention of a specific product in a song. Pricing of placements has not previously been standardized in the way that pricing for conventional advertisements have. Thus, creating a model and an automated method for estimating the value and hence price of a placement is itself novel and unique.

Another important difference between a placement and a conventional advertisement is that the advertiser creates an advertisement and control over every aspect, for example the content, and duration. Typically, a placement is purchased by a media buyer prior to its being created; and it is created as part of the creation or production of the vehicle itself.

Product placement opportunity, or opportunity—means a potential placement in a vehicle that may be purchased by a media buyer.

Placement quality—refers to a rating of the relative importance or prominence of a brand or product placed within a vehicle. Factors used to assess placement quality include prominence of the item. For example, if the placement is for a soft drink in a TV show, if the soft drink is prominently displayed in the hands of a major star then the placement quality would be very high; on the other hand, if the soft drink is on a table in the corner then the placement quality would be low. Another factor that may be used to assess placement quality is the treatment of the item. For example, if the placement is for a particular brand of coffee, do the actors in the scene appear to be enjoying the coffee? Another factor is whether the placement is integrated into the storyline of the vehicle. Yet another factor is whether there is a verbal or nonverbal mention of the product in the vehicle. In one embodiment placement quality is specified using a scale of Premium, Prominent and Standard where Premium is the high quality placement and Standard is a low quality placement.

While vehicle power may be assessed before a placement is made, the placement quality can only be evaluated after a placement has been produced, or created, and is integrated into a vehicle since many of the criteria used to evaluate placement quality, e.g. visibility of product, are under the control of the producer or director of the vehicle and cannot be known in advance of production. Note that as used herein the terms “creation” and “production” are used synonymously and refer to the process of creating a media vehicle such as a movie, typically using digital media tools for creating media such as film and video editors and sound mixers.

Placement duration or simply duration—refers to the amount of time during a media segment, e.g. during a film or TV show or song, that a placement occupies. For example, if a placement consists of an actor holding a can of soda in a film the duration would be the length of time in which the actor appears holding the can of soda. Similar to placement quality, the duration of a placement can typically only be evaluated after a vehicle in which a placement appears has been produced since decisions affecting the duration of a placement are made during production.

Media buyer or buyer or user—means an individual that uses a mobile device, PC or other electronic device to access and use a product placement service available across a network, typically with the objective of specifying a media plan, purchasing placements, or evaluating results from implementation of a media plan by the placement service.

### Generalized Operation

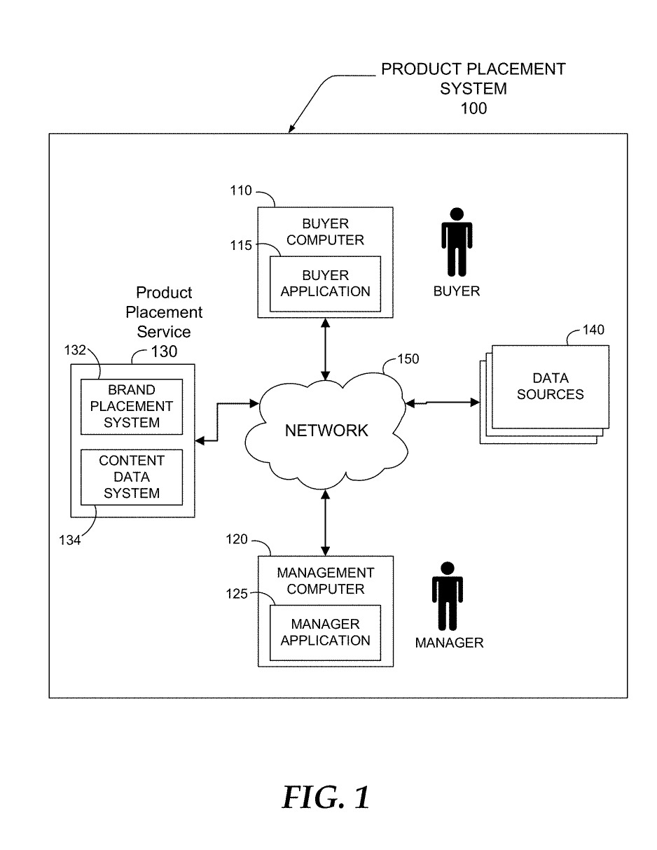

The operation of certain aspects of the invention is described below with respect to FIGS. 1-8.

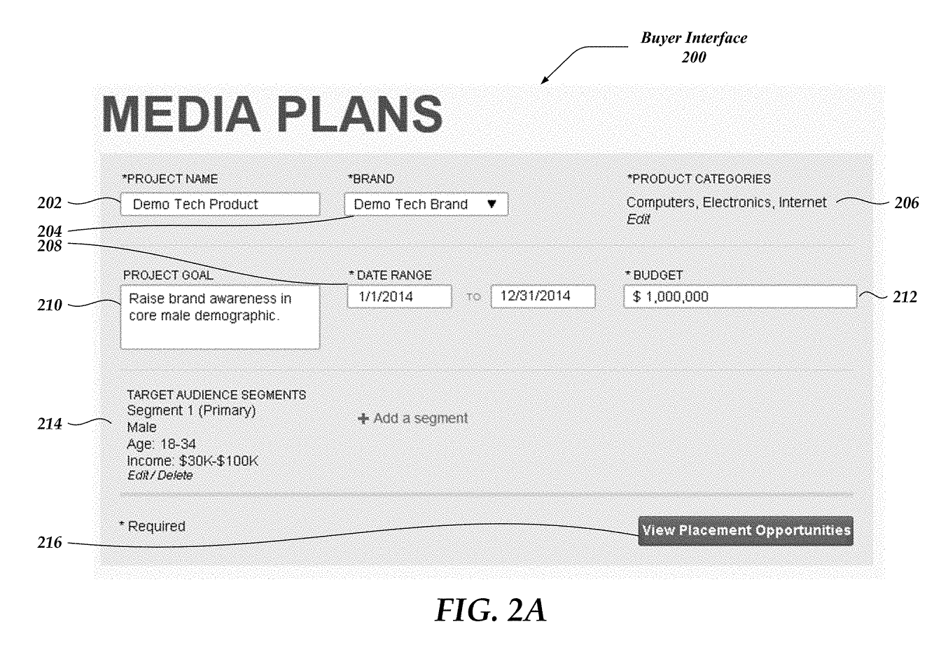

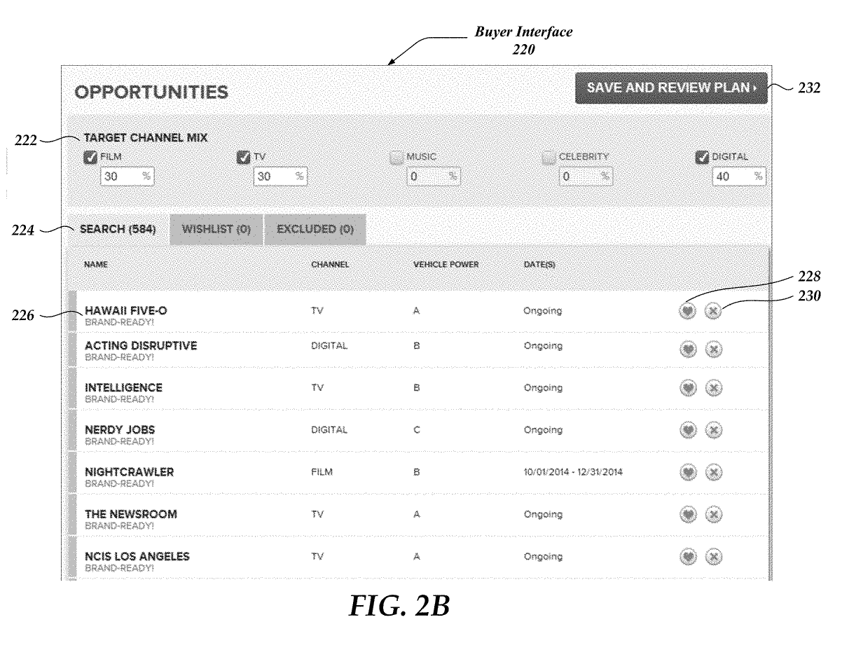

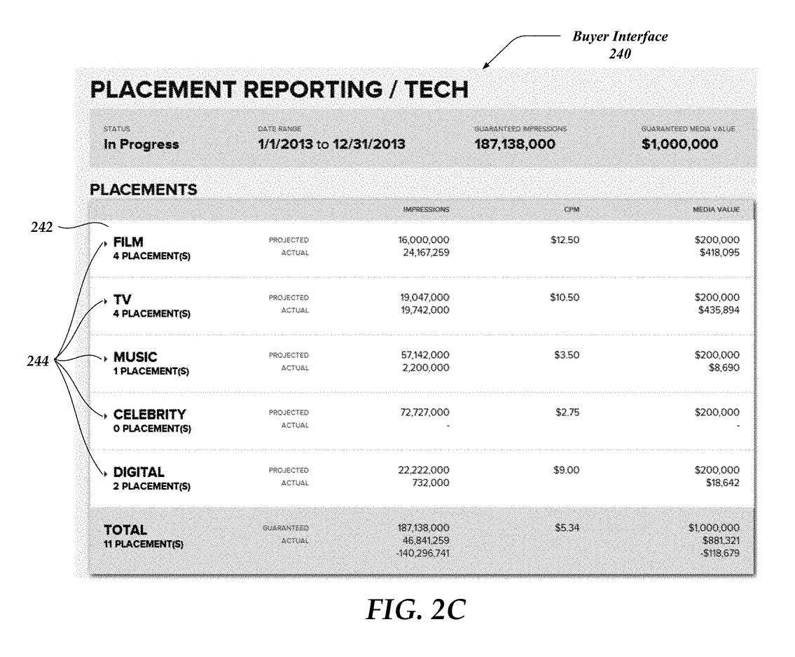

FIG. 1 is a generalized block diagram of a preferred embodiment of an online product placement system in which a product placement service enables a media buyer to specify a media plan, and then searches for product placement opportunities that conform to the media plan. A media buyer, hereinafter referred to simply as a buyer or user, uses a buyer application 115 that runs in a buyer computer 110 to perform some or all of the following functions: specify, define, edit or modify a media plan, specify filters, and view summary and detailed results from execution of a media plan. Buyer application 110 is described in further detail hereinbelow with reference to FIGS. 2A-C. Buyer application 115 may include one or more Web browser-based applications and/or mobile apps delivered across a network from a product placement service 130 and executed by buyer computer 110, one or more mobile applications, or it may be one more applications that are separately downloaded or installed from other media such as a USB drive or other external storage medium, into buyer computer 110 for execution by a buyer.

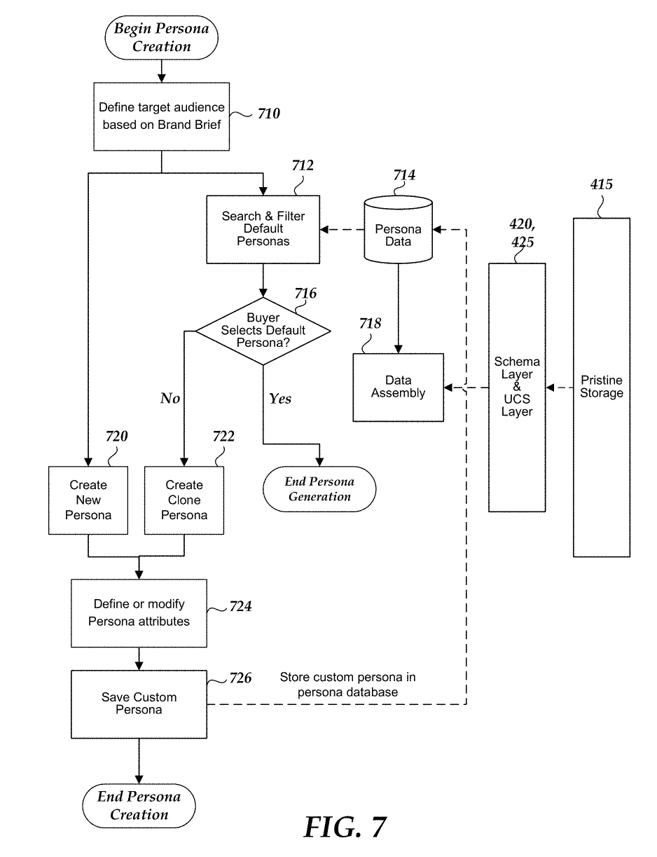

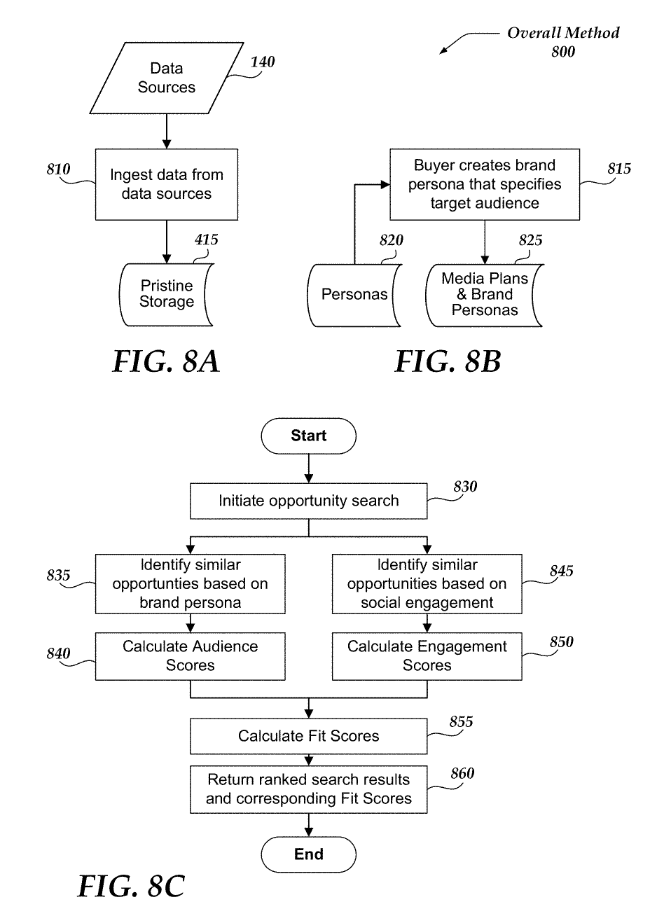

Product placement service 130 refers to a service that is available across a network 150 that enables a buyer to specify and implement a media plan across multiple types of media. Product placement service 130 may be implemented by one or more server computers acting cooperatively or by a network service, or “cloud” service provided by a third party. One embodiment of a server-based approach to implementing product placement service 130 is described hereinbelow with reference to FIGS. 7 and 8. Placement service 130 provides services across network 150 to a buyer computer 110 and to a management computer 120.

A manager of placement service 130 ensures that placement opportunities are available to a buyer using buyer application 115 running on buyer computer 110. A manager uses a management application 125 that runs in management computer 120 to interact with management functions provided by product placement service 130. Management functions may include defining or providing data for vehicles, opportunities and placements, determining and entering vehicle power values for opportunities, determining and entering placement quality values for placements after they have aired and maintaining a database of buyers with up-to-date buyer information. Manager application 123 and buyer application 115 may be implemented as a single application that presents various user interfaces depending on the role, rights and authorization of a particular user.

Product placement service 130 maintains a database of product placement opportunities, also referred to herein simply as opportunities. Each opportunity refers to a potential product placement within a vehicle such as a television program, social media network, song or movie. Once an opportunity is included in a media plan and executed as part of a placement campaign it is referred to as a product placement or simply as a placement.

Product placement service 130 includes a content data system (CDS) 132, which is a data system that includes a data warehouse that receives and stores information about vehicles, opportunities, audience data, and social media engagement from various external data sources 140. CDS 132 receives and stores external data from data sources 140 and processes the data to generate opportunity objects, or opportunities. The opportunities are then compared to target audiences defined by a buyer in order to determine audience scores, and to social engagement data to determine engagement scores for each opportunity.

Product placement service 130 also includes a brand placement system 132 that performs a variety of user requested processes such as creating a media plan, selecting opportunities for inclusion in a media plan, searching for and reviewing vehicles and opportunities, and defining target audiences.

Data sources 140 may be publicly available databases or services or private information services. Table 1 below, gives an example of data that may be obtained from data sources 140 for different channels. This information is available from a variety of companies and organizations including, for example, THE NIELSEN COMPANY, COMSCORE, and GOOGLE.

TABLE 1
Example external data sources

| | Type of Data Available From |
|---|---|
| Channel | External Data Sources |
| Film (movie) | Number of impressions per |
| | geographic territory; |
| | demographics of audiences. |
| Television (broadcast, | Impression counts; |
| streaming, video on | demographic profiles for |
| demand) | impressions. |
| Digital (video accessed | Impression counts and |
| across the Internet, | demographics of viewers. |
| includes video ads in | |
| Web pages as well as | |
| video shows) | |
| Music Video | Impressions and demographics |
| | of viewers. |
| Celebrity Image for | Publication in which celebrity |
| Print Media | seeded images are published; |
| | average circulation of each |
| | publication and demographic |
| | profile of viewers. |
| Celebrity Images for | List of URLs that identify Web |
| Web Media | pages that publish seeded |
| | celebrity images; impressions |
| | and demographics of viewers. |
| Social Media Network | Social media audience profile |
| | and engagement data. |

FIGS. 2A-C are embodiments of a user interface implemented by buyer application 115. In one embodiment, each of FIGS. 2A-2C correspond to an interactive Web page that is provided by placement service 130 to buyer computer 110 to be displayed by buyer application 115.

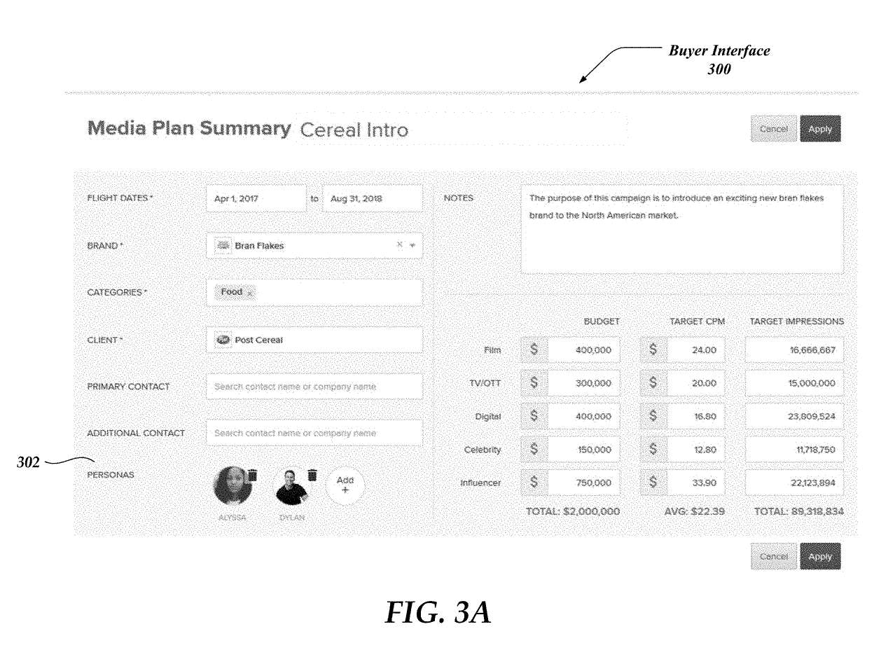

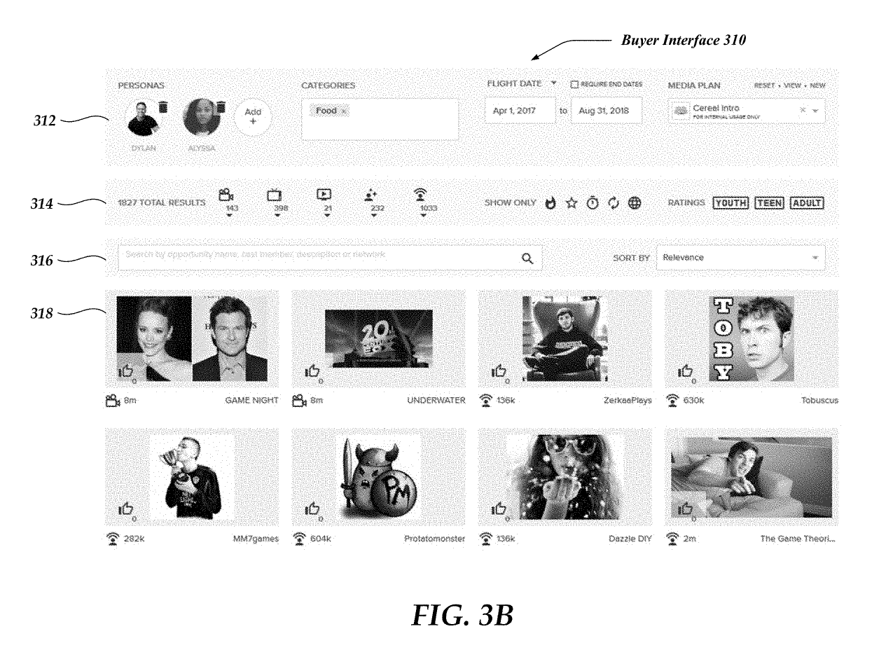

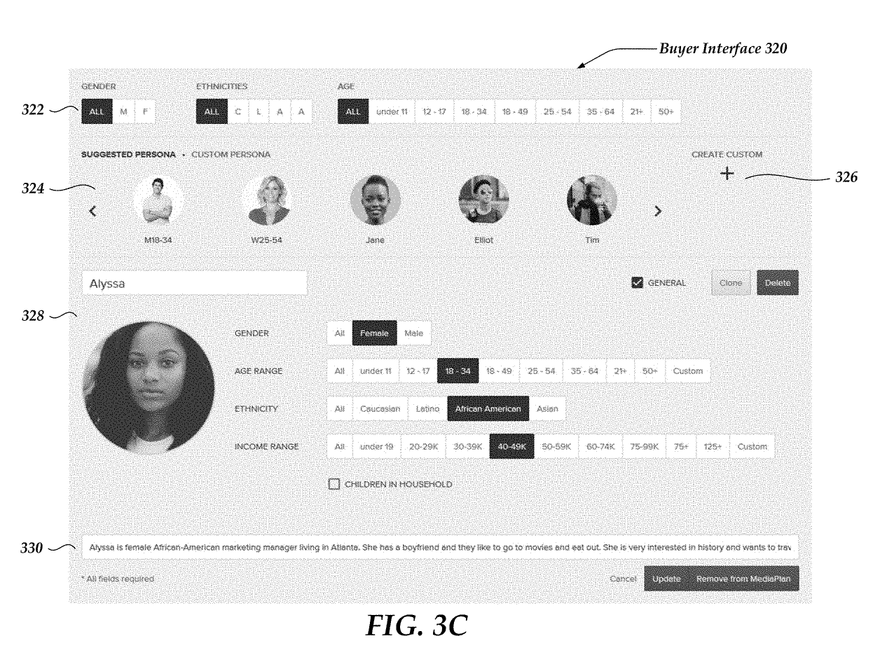

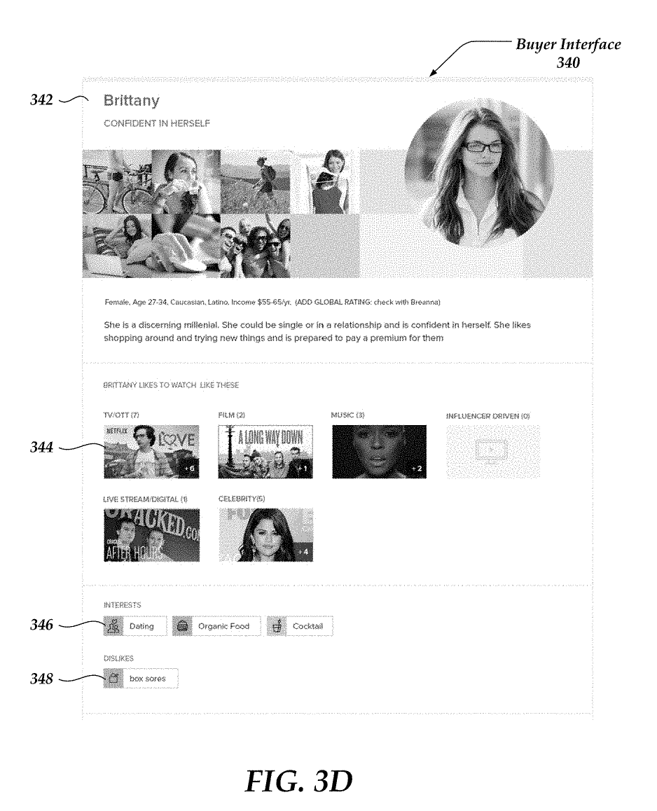

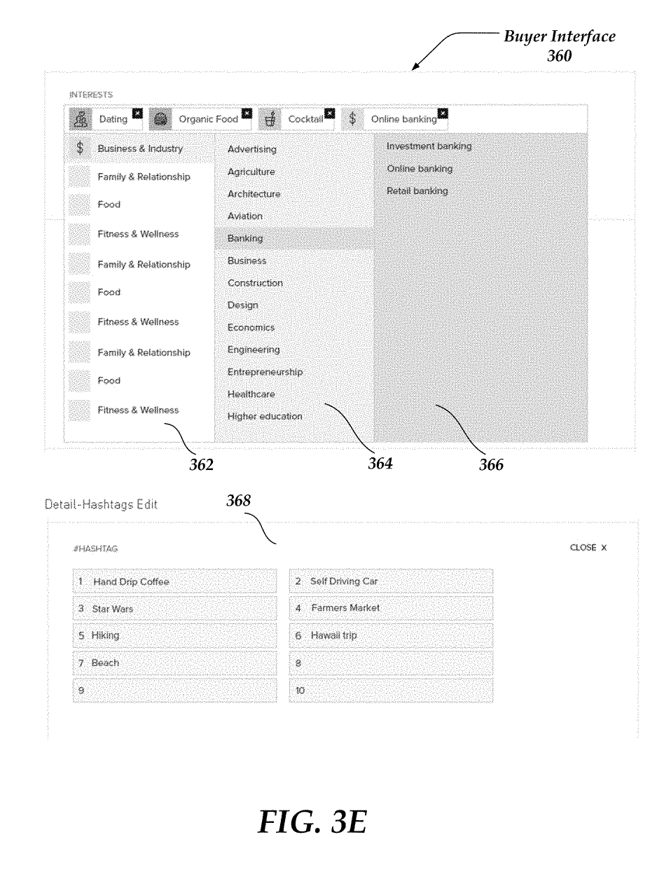

FIG. 2A illustrates one embodiment of a user interface that enables a buyer to specify requirements for a product placement media plan. Buyer interface 200 includes entry box 202 that enables the buyer to specify a project name, pull down menu 204 that enables the buyer to specify a brand or product line or company, entry box 210 that enables the buyer to enter a project goal, and date boxes 208 that enable the buyer to specify a date range, depicted as a starting date and ending date, for the campaign that executes the media plan. In addition, buyer interface enables the buyer to specify product categories 206, and a campaign budget 212. A set of segment controls 214 enable a buyer to specify one or more market segments, or target audiences to be addressed in the media plan. Segment information that may be specified include gender, age, geography, income, occupation, buying preferences, race, nationality and the like. Multiple market segments may be defined as target segments using segment controls 214. The union of the various segments or audiences specified by a buyer is referred to as a “target audience.” One embodiment, that uses a visual representation of target segments or audiences, referred to as a persona is described with reference to FIGS. 3A-D.

When a user finishes specifying the information requested in buyer interface 200, he/she presses a control 216 to indicate the placement service 130 that he/she is finished. Buyer computer 110 then transmits the media plan information to placement service 130 for further processing.

FIG. 2B illustrates one embodiment of a user interface that enables a buyer to specify a channel mix for a product placement media plan and to interactively select and reject product placement opportunities provided by a product placement system. In response to the media plan inputs provided by a buyer using buyer interface 200, placement service 130 identifies and provides a list of available opportunities to buyer computer 110 for display to the buyer. Buyer application 115 provides buyer interface 220 to the buyer, which enables him/her to view and further refine opportunities selected for inclusion in the media plan. In certain embodiments, the buyer may indicate preferences as well as make comments and otherwise interact with opportunities. A channel mix control 222 enables the buyer to specify the allocation of the budget among each media channel. While the channels illustrated in this example embodiment include film, TV, music, celebrity and digital (i.e. Web media), other channels, such as social media, may be included or channels illustrated may be omitted without departing from the scope and spirit of the subject invention. Further, in some embodiments channel mix control 222 specifies a target allocation of impressions, budget or CPMs. Using controls 224 the buyer can view opportunities, wishlist items and excluded opportunities. In this embodiment, an opportunity list 226 displays a list of opportunities identified by placement service 130 as being consistent with the media plan specified by the user and available for placements. Additionally, the buyer can perform keyword searches to select individual opportunities or groups of opportunities for inclusion or exclusion in the media plan. In this embodiment, two controls are available for each opportunity. An include control 228 enables the buyer to indicate that he/she wants to include the opportunity and similar opportunities in the media plan. Included opportunities are added to the wishlist. An omit control 230 enables the buyer to indicate that he/she wants to omit the opportunity and similar opportunities from the media plan. Omitted opportunities are added to the excluded list. In other embodiments, include control 228 is used to indicate that a specific opportunity should be included and omit control 230 is used to indicate that a specific opportunity should be excluded. When the buyer completes selecting opportunities he/she uses a save control 232 to indicate that he/she has finished specifying opportunities. Additional or different controls may be provided to assist in specifying opportunities to include in the media plan without departing from the spirit and scope of the subject invention.

FIG. 2C illustrates one embodiment of a user interface, referred to as buyer interface 240, which summarizes the results of a single placement campaign based on a media plan. Buyer interface 240 includes a delivery and impact panel 242 that displays campaign results for each channel included in the media plan. Buyer interface 240 displays results information including the number of projected and actual impressions achieved for each channel, the projected CPM, and the projected and actual media value. Additional detail about each channel may be obtained by selecting a more detail control 244 that appears to the left of the name of each channel.

### Persona Based Matching

As illustrated in FIG. 2A, specifying one or more target audiences that are used for matching opportunities to a media plan is key step in media planning. A visual approach to specifying a target audience, referred to as persona based matching (PBM), is described hereinbelow that more directly utilizes information provided by brands concerning the target audiences for their advertising and product placement campaigns. In some cases, this information concerning target audiences is supplied by a brand in a document, commonly referred to as a brand brief. In other cases, the information is communicated through less formal means, such as through conversations, memos, and the like.

Typically, a brand specifies a target audience as a series of personas, which are named, fictitious, individuals each of which represents a specific audience. The union of the specific audiences is referred to as the brand audience or target audience. The target audience is defined by a set of characteristics, which may typically include demographic details such as age, gender, ethnicity, and psychographic details such as personality traits, values, attitudes, interests, and lifestyles or behaviors that typify the desired audience for the brand. Thus, the term persona as used herein refers to a visual representation of a fictitious individual that represents a specific, target, audience. As such, a persona represents or specifies the characteristics of a desired audience which may include demographic, psychographic and behavioral characteristics. The ability to refer to, select and manipulate audience characteristics using visual personas is a novel and unique characteristic of certain embodiments of system 100.

In the subject invention, data is provided by brands to product placement service 130 by a buyer or by staff.

FIGS. 3A-D present an embodiment of buyer application 115 that enables a buyer to specify a target audience using a visual, persona-based approach.

FIG. 3A illustrates how personas are used in a media planning interface 300 to define a target audience. The term target audience is used because the personas represent the audience that a brand, or buyer representing a brand, wants to reach through a product placement campaign. The brand audience and media plan specified using buyer interface 300 applies to a single campaign. The term “brand persona” may also be used to reflect the combination of one or more personas to represent the target audience.

Buyer interface 300 enables the buyer specifies a target audience for a campaign using personas. The buyer uses a target audience control 302 to select personas for inclusion in the target audience. As illustrated, the buyer has selected two personas, named Alyssa and Dylan, which in combination specify a brand persona, or target audience, for the campaign. In certain embodiments, a buyer can adjust the percentage contribution, or relative weight, of each persona. For example, a slider, or other control, may be available that lets the buyer adjust the contribution of a persona upward or downward. Additionally, in certain embodiments, it is possible to adjust the weight or importance of certain attributes of a persona.

FIG. 3B illustrates an embodiment of a search results buyer interface 310. In certain embodiments, brand placement system 132 initiates an opportunity search after a buyer creates a media plan using buyer interface 300. An opportunity search searches for available opportunities that match the brand persona created using buyer interface 300. A summary panel 312 summarizes data from the media plan, including personas, categories, flight date and name. An opportunity summary panel 314 provides data that summarizes the opportunities determined by the opportunity search. In the example, 143 films, 398 TV shows, 21 Web ads, 232 celebrity endorsers and 1033 social media influencers were returned. The buyer can filter the opportunities based on ratings and other criteria. A search box 316 enables a buyer to enter search criteria including opportunity name, cast member, network or keywords. Additionally, the search can be sorted according to various criteria, including a Fit score, an audience score, an engagement score, and media type. In this example, results are displayed as rectangular boxes with a thumbs up icon, a name, and an indicator of the type of media. Clicking on the thumbs up icon indicates that the buyer wants to consider the opportunity for inclusion in the media plan. Although not depicted in this example, results are returned along with one or more scores. Scores may include an engagement score, an audience score and a Fit score, which are discussed hereinbelow. In certain embodiments, one or more of the scores is used to order the search results. Further, in certain embodiments one or more of the scores may be displayed to the buyer.

FIG. 3C provides an embodiment of a buyer interface 320 that enables a buyer to select personas, view characteristics of personas, create new personas and edit personas. A persona filter panel 324 lets the buyer specify filters to apply when presenting or searching for available personas. Photos that represent personas that meet the characteristics defined in the persona filter panel 324 appear in a persona carousel 324.

A create custom control 326 allows a buyer to indicate that he/she wants to define a new or custom persona. In certain embodiments, a clone persona is used as the basis for creating a new persona and a clone persona inherits the characteristics of the currently selected persona. After a clone person is created the buyer uses a persona detail interface 340 to edit the characteristics of the clone persona.

A characteristics panel 328 shows a representative image 330 and enables a buyer to specify the characteristics of a persona, such as a name, gender, age range, ethnicity, income range and whether there are children in the household. In this example, characteristics for persona, referred to as Alyssa, which has already been included in a media plan are displayed. A textual description 332 provides a summary of the persona. In certain embodiments, selecting image 330 opens a buyer interface 340 that shows and enables the buyer to edit additional characteristics of the selected persona. It may be appreciated that characteristics panel 328 provides demographic details; however, generally a persona may include a wide variety of characteristics including demographic, psychographic, behavioral and social.

An example buyer interface 340, illustrated in FIG. 3D, enables a user to view and edit persona details. Buyer interface 340 includes a sample of the full set of characteristics that characterize the selected persona. The example characteristics depicted in buyer interface 340 include media Brittany prefers 344 such as television (TV) and Over the Top (OTT) programming (an industry term to denote nontraditional video programming such as that from NETFLIX and other streaming media providers, and certain cable TV providers), music, social media influencers, live streaming and digital/Web interests, and celebrities, other interests 346 and dislikes 348. Other characteristics that may be available from buyer interface 340 but which are not depicted include social networks he/she uses, preferred brands, conversation topics, e.g. hashtags used in online comments, other media that they watch or engage with, related or similar personas.

FIG. 3E illustrates an additional example of a buyer interface 360 that may be used to edit detailed characteristics for a persona. Buyer interface 360 enables a buyer to select one or more interests listed in a panel 362. Panel 364 enables a user to select a category of interests, e.g. banking, and a detailed interest within the category using a panel 366, which shows three banking areas of detailed interest. A hashtags panel 368 enables the buyer to enter hashtags that characterize areas of interest for the persona.

Taken together, the user interfaces and features illustrated in FIGS. 3A-D provide a visual means to specify a target audience which itself is composed of distinct populations or audiences, each of which is represented by a persona. This approach corresponds to the way in which brands specify their desired target audiences in brand briefs that they supply to advertising companies.

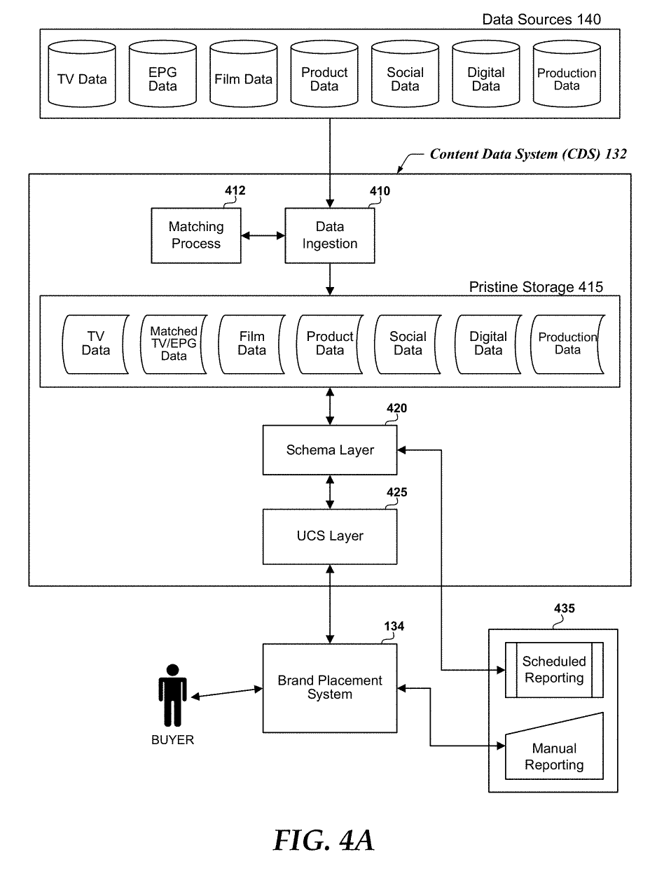

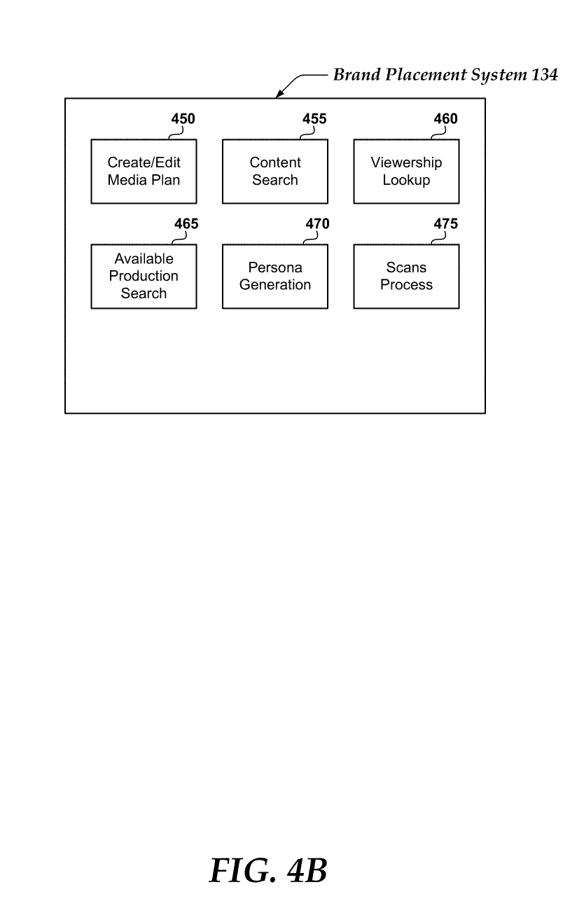

FIGS. 4, and 6-10 are flow and component diagrams in which each graphical element, including rectangles, cylinders, and triangles, can be implemented by computer program instructions. These program instructions may be provided to a processor and then executed by the processor, thus creating means for implementing the actions represented by the graphical element. The computer program instructions may be executed by a processor to cause a series of operational steps to be performed by the processor to produce a computer-implemented process such that the instructions, which execute on the processor to provide steps for implementing the actions represented by the graphical element. Some of the computer program instructions may be performed in parallel, or across more than one processor, such as might arise in a multi-processor computer system. In addition, the actions represented by one or more graphical elements may also be performed concurrently with actions represented by other graphical elements, or even in a different sequence than illustrated without departing from the scope or spirit of the invention. It will also be understood that the actions represented by each graphical element and by combinations of graphical elements can be implemented by special purpose hardware-based systems that perform the specified actions or steps, or combinations of special purpose hardware and computer instructions.

FIG. 4A is a simplified block diagram of a content data system (CDS) that collects and ingest data from external data sources 140 and incorporates internally generated data to create opportunity data objects that can be evaluated against target audiences. Data sources 140 provide data required to: identify vehicles for placements, i.e. opportunities, and to provide data for viewing by a buyer, reporting, and analysis by placement service 130.

Data sources 140 includes (1) content and programming data such as electronic program guides (EPG) such as that provided by GRACENOTE and information pertaining to television and film vehicles in production and pre-production such as that provided by VARIETY, (2) viewership data, including audience demographics and impressions, for specific media such as film and television such as that provided by NIELSEN, RENTRAK and COMSCORE, and (3) consumption and behavior data, including social activity and interests, such as that provided by MRI and NIELSEN/SCARBOROUGH. Other sources may be used for specific media channels such as social networks including SHAREABLEE and CRIMSON HEXAGON.

It may be appreciated that the ability to match a target audience, such as that specified by a brand using personas, with opportunities across a variety of data sources including film, TV, social networks, Web, content and programming data, viewership data and consumer behavior is both challenging and novel. Traditional advertising platforms do not typically take into account psychographic and behavioral information. The use of personas by the subject invention makes it possible to characterize target audiences more easily and more broadly than has previously been accomplished.

In certain embodiments, data from data sources 140 is ingested and stored using a cloud storage facility. A data ingestion 410 component provides several methods for ingesting such external data, including (1) use of APIs supported by the provider of the data source, (2) use of a dashboard provided by the data source which enables a user to obtain data, (3) custom ingestion methods developed for data sources that have nonstandard formats, such as a cross-tabbed relational database, and (4) manual input, for example, extracting data from printed or electronic reports supplied by the data source by a staff person and entering the data into forms, database fields, or other files. The term dashboard as a process within data ingestion 410 refers to steps typically performed by a staff person using an interface provided by the data source to obtain and ingest data.

In certain cases, data from data sources 140 is matched and processed to create intermediate results that are more convenient for subsequent processing steps. For example, a matching process 412 combines information about TV episodes from an electronic program guide (EPG) with TV viewership data to allocate viewership to specific episodes of TV shows.

Data retrieved and processed by data ingestion 410 is stored in a storage facility, referred to as pristine storage 415. In certain embodiments, pristine storage 415 stores data in its original or source format, i.e. all subsequent transformations and processing such as formatting and mapping by data schemas are performed based on pristine, i.e. original, versions, of the data. Pristine storage 415 is a data warehouse that stores historical data sets from a plurality of data sources 140 as well as internally generated data such as media plans.

A schema layer 420 performs data normalization and standardization functions required to efficiently access, search on, process and report on opportunities and placement campaigns, as performed by brand placement service 134. Normalization ensures that data in pristine storage 415 is transformed to use naming and formatting conventions used by brand placement system 134. For example, TV and film data may include viewership demographics but the age and income brackets may be quite different as the data comes from different vendors. Standardization is performed as part of schema processing and includes processes such as creating specific views of the data and generating opportunity data objects that describe opportunities.

Other types of normalization include: viewership numbers, sales metrics, viewership metrics, social media metrics (e.g. clicks vs. likes).

Schema layer 420 may be used to analyze viewers of a specific program, e.g. the TV program WALKING DEAD. For example, product data can be cross tabulated with TV program data to identify the percentage of viewers of WALKING DEAD who drink COCA COLA

Schema layer 420 may further be used to define a variety of reports, to be used by a scheduled reporting 435 process.

A UCS layer 425 acts as a secondary schema layer. UCS layer 425 processes requests made by buyers using brand placement system 134 and generates appropriate schemas and queries that are processed by CDS 132. UCS layer 425 also integrates internally generated data such as media values and audience and engagement metrics into results that it returns to brand placement system for display to a buyer.

FIG. 4B illustrates an embodiment of processes performed by brand placement system 134. The brand supplies information from its brand brief to brand placement system 134. Typically, this is accomplished when a buyer, representing the brand, selects, edits or creates one or more personas that correspond to the brand brief, using buyer application 115 running in buyer computer 110.

Brand placement system 134 receives personas from a buyer and content information from data sources 140 and provides user interaction, planning, campaign management and execution, and reporting. In addition, brand placement system 134 runs a number of asynchronous processes.

### Opportunities

In certain embodiments, brand placement system 134 relies on internal staff or contractors to analyze information about vehicles such as TV shows, films, and influencers to identify placement opportunities. The staff then input a variety of information about the opportunities, which is stored in an opportunity database as opportunity objects. For example, staff may review the script for a movie and identify certain categories of products, e.g. jewelry or automobiles, that are referenced in the script. Especially attractive placement opportunities may be identified as highly desirable. In addition, in certain embodiments, computer intelligence techniques such as keyword search, natural language processing (NLP), machine learning, and artificial intelligence (AI) may be used to analyze vehicle data such as scripts, closed captions, and social media to automatically generate information for inclusion in the opportunity objects or to assist staff in evaluating potential opportunities.

In certain embodiments, brand placement system 134 discovers opportunities and generates and stores corresponding data objects.

An opportunity data object typically includes program information, schedule information, viewership information, behavior information, and consumer purchase information; each of these types of information typically comes from a different one of data sources 140. Some of the component data included in an opportunity object may be stored at the time the opportunity is discovered; other elements of the opportunity object may be obtained or calculated on-the-fly, i.e. as needed for viewing, reporting, etc. Information from opportunity data objects is subsequently displayed to the buyer as opportunities that can be reviewed, selected and incorporated into a media plan.

Table 2, below, lists the types of information that are included in an opportunity object.

TABLE 2
Information in an opportunity object.

| Category | Description/Examples |
|---|---|
| Vehicle information | Directors, producers, writers, cast, |
| | production company, genre, rating, |
| | sensitivities, vehicle power, etc. |
| Social media | Sites that cover the vehicle |
| | (FACEBOOK, etc.), subscribers, |
| | followers, likes, etc. |
| Production information | Upcoming episodes, upcoming films, |
| | production status, etc. |
| Program schedule/EPG | Episode number, title, date & time to |
| | be shown |
| Viewership information | Impressions, audience demographics |
| Product usage and | Brand preference & behaviors |
| purchase behavior | |
| Desirable placements | Brand categories, opportunities for |
| | integration of placements |
| Data generated by | Vehicle power, similar productions, |
| placement service | projected impressions, CPM, media |
| | value |
| Audience profile | Age, income, gender, ethnicity, |
| | children in household |

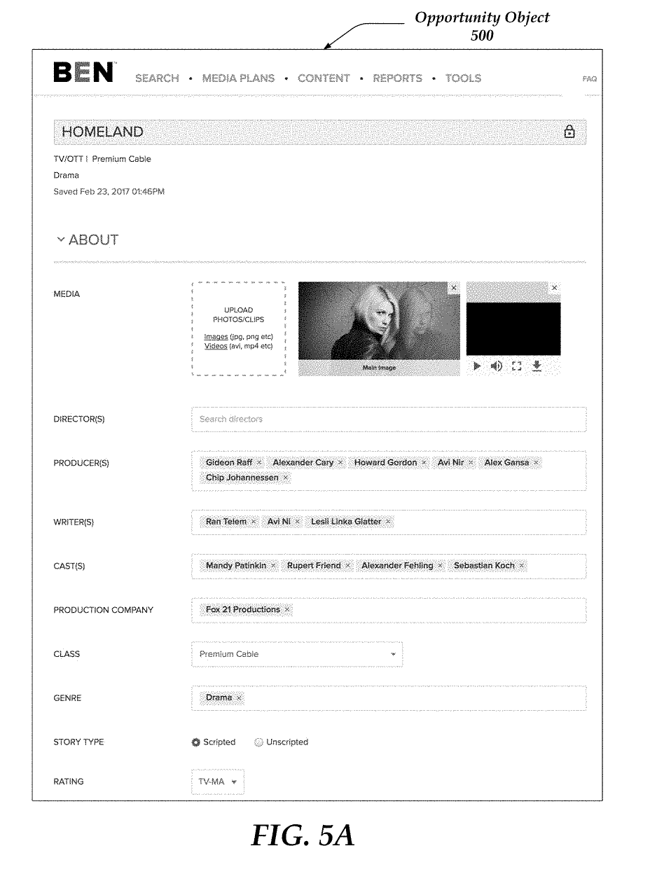

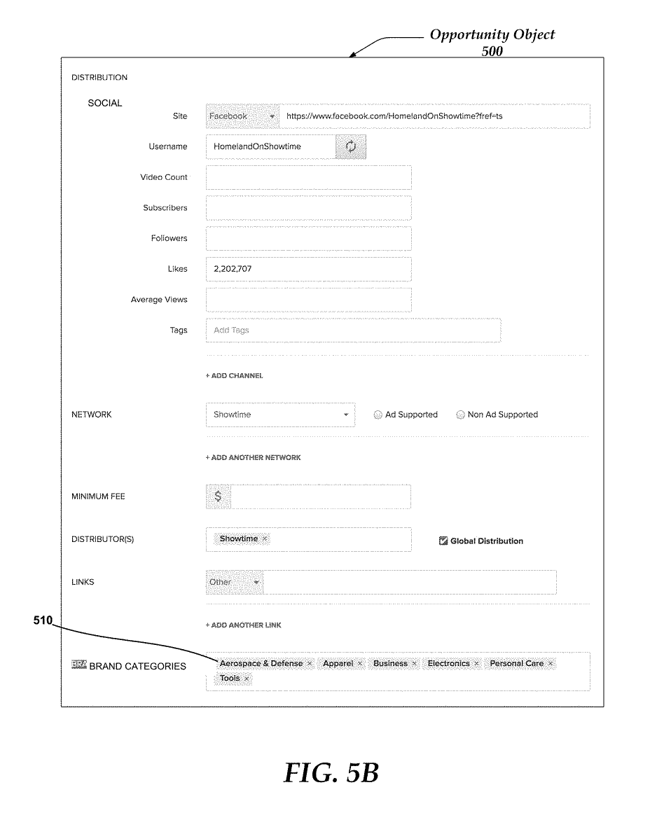

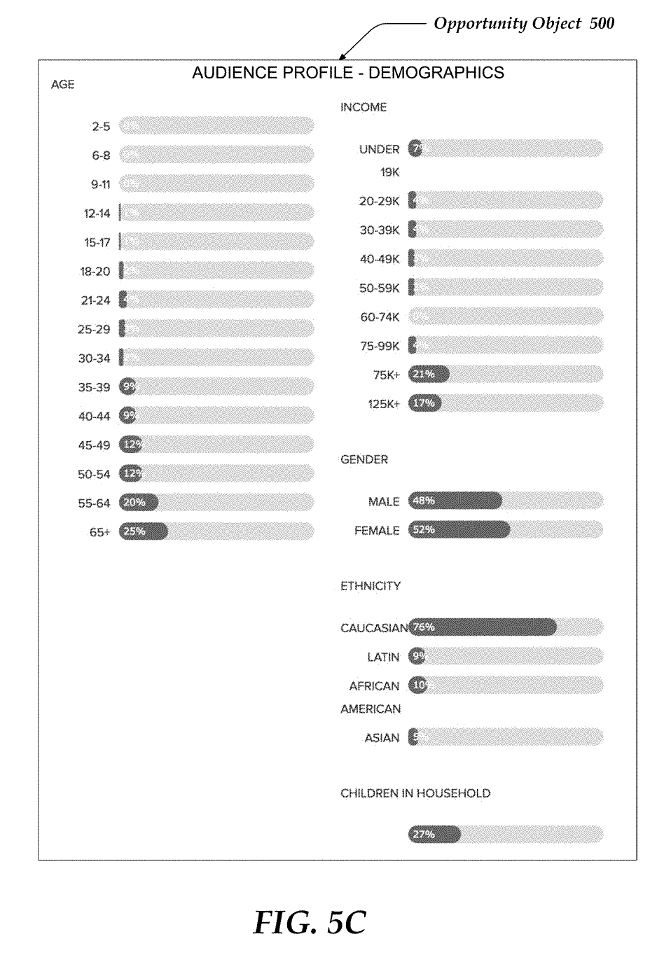

FIGS. 5A-C provide an example visual depiction of the data included in an opportunity data object. The illustrated opportunity corresponds to the TV series HOMELAND. Generally, an opportunity data object, such as that depicted, includes data collected from data sources 140, data that is collected and then processed to achieve a desired format, and new types of data such as vehicle power and media value that is generated by brand placement system 134. An example of data generated by brand placement system 134 and incorporated into a data object is brand categories 510 illustrated in FIG. 5B. The categories in this list correspond to desirable placement categories that are available in episodes of the HOMELAND TV series.

### Audience Score

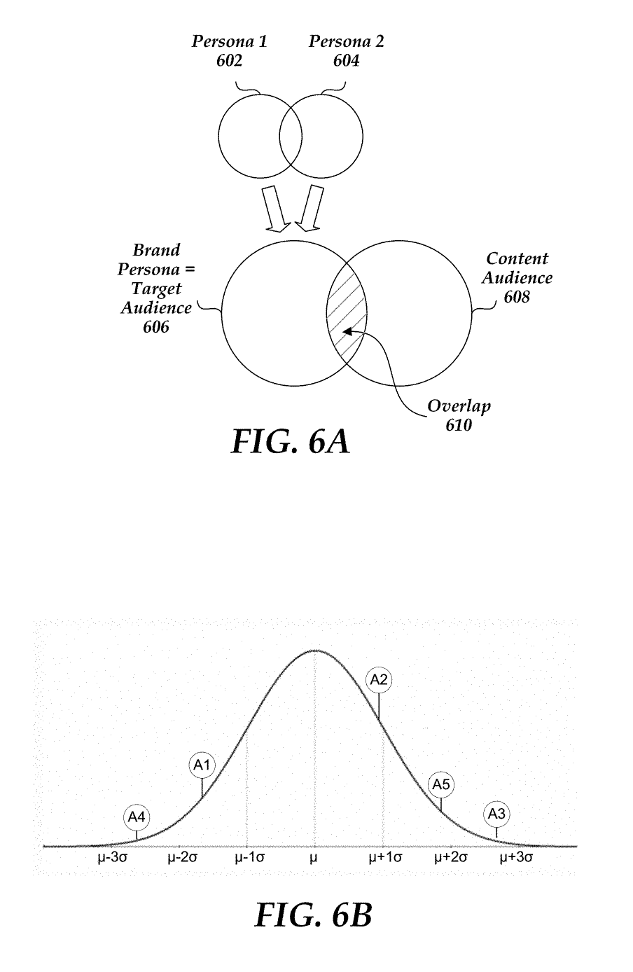

FIGS. 6A-B illustrate a general framework for determining a measure of matching, referred to as an audience score, between a target audience defined for a brand campaign and the measured audience for an opportunity. An audience score is a quantitative measure that defines the extent to which an opportunity matches or fits with a target audience for a brand as specified in a media plan. In certain embodiments audience score may be a relative measure, such as a ranking, of an opportunity in relation to other opportunities or the ranking of a target audience relative to other target audiences. For example, if 100 audiences have been defined, each corresponding to a different persona, then 100 different audience scores can be calculated and then ranked from 1 to 100. Alternatively, the scores can be further processed to obtain statistical measures such a mean and standard deviation.

FIG. 6A illustrates the relationship between a target audience defined for a brand and a content audience for an opportunity. In FIG. 6A, two audiences 602-604, each defined by a different persona, e.g. Alyssa and Dylan from FIG. 3A, and each represented in the figure by circles, constitute the target audience for a brand campaign. The combination, or union, of the two personas, represented by the large circle 606, form a brand persona that also defines the target audience. The target audience, as previously discussed, is the desired audience that a brand wants to reach with a placement campaign. As previously discussed, measurements of the audience for specific opportunity, referred to as a content audience 608, are obtained by CDS 132. The audience score is a measure of the overlap 610 between the target audience and the content audience. While the target audience and content target audience are illustrated as circles, in fact they are multidimensional in that each is characterized by a wide variety of characteristics including demographics, psychographics and behaviors.

FIG. 6B presents a simplified example of scoring a target audience, as represented by a brand persona, relative to an audience for a vehicle or opportunity. In this example, five different audiences are scored, each corresponding to a different brand persona. Each brand persona is evaluated relative to an opportunity; in this case the opportunity is a placement in one or more episodes of the TV series HOMELAND. The actual audience for HOMELAND is obtained from data sources 140 and is processed and stored by CDS 132. The unit of measurement on the horizontal (X) axis is number of standard deviations (σ) from the mean (μ), where the mean is the statistical mean amount that a defined population overlaps with the measured audience for a program or opportunity. Thus, in the example, audience A3 receives the highest score at just under 3 standard deviations above the mean. A3, overlaps to a high degree with the actual HOMELAND audience.

It may be appreciated that a normal distribution curve is shown but that other distributions may also be used without departing from the spirit or scope of the subject innovation. Other mathematical approaches to scoring can also be used. For example, the audience score for an opportunity may be a value from 1 to 100 or a percentage that reflects how close the opportunity is to a perfect match with the defined target audience.

An example of one simplified method to determine an audience score is shown below in Table 3. The audience score in this case is the percentage overlap between an item of content, named “Great Show” and a single persona (Alyssa, from FIG. 3B). The rule used for this simplified example is, for each characteristic, to calculate the fraction of the content audience that overlaps with the desired target audience. The column labeled overlap identifies the items or range that are common to both the target audience and the content audience.

TABLE 3
Example of computing audience fit for a single persona

| | | Measured | | |
|---|---|---|---|---|
| | Persona = | Audience for | Overlapping | Audience |
| Characteristic | Alyssa | Great Show | Portion | Score |
| Gender | Female | Female 80% | Females in | .8 |
| | | Male 20% | Great Show | |
| | | | Audience | |
| Age Group | 18-34 | 18-40 | Ages 18-34 | 16/22 = |
| | | | | .72 |
| Ethnicity | African | African | African | .5 |
| | American | American | Americans | |
| | | 50% | that watch | |
| | | Caucasian | Great Show | |
| | | 25% | | |
| | | Latino 25% | | |
| Interests | Dating | Dating | Dating | 1/3 = |
| | Organic Food | Sports | | .333 |
| | Cocktails | Music | | |

In this simplified example, all characteristics are given equal weights. The audience score is computed as the average of the audience fit values for each characteristic, thus audience score=(0.8+0.72+0.5+0.333)/4=0.59

In other embodiments, more granular analysis may be used. For example, different ethnic groups may be weighted based on their percentage of a population, certain interests may be weighted more highly than others, and the like. Further, audience fit may be computed in other ways. Yet further, this method applies to computing an audience fit when the brand target audience is composed of more than one persona since a brand persona is generated by taking the union of the characteristics for each individual persona specified for the brand.

Audience score is a novel measure that can be used, for example, to order the list of opportunities returned from a search by a buyer. Further, the audience fit may be displayed for each opportunity in a list, providing the buyer with a critical measure with which to compare placements. Essentially, audience fit is a measure that provides unique guidance to a media planner or buyer when reviewing and selecting placement opportunities.

### Engagement Score

Factors other than the overlap between the desired audience for a brand as specified by the target audience and the content audience for various available opportunities may be desirable. One factor that has been identified is the degree of social engagement by an audience, referred to herein as an engagement score. Generally, the engagement score measures the social media engagement of an audience with a particular vehicle. For example, the engagement score might indicate that viewers with a preference for the TV show RAY DONOVAN are more active on social media and are more likely to mention or discuss the show than viewers of the TV show NCIS. Thus, for each opportunity an engagement score may be computed that measures the extent of the social activity or engagement by its audience. This score may be used to recommend opportunities to brands based on the social engagement of the brand's target audience with the opportunities.

An engagement score may be computed for the entire content audience for an opportunity, i.e. a measurement for the entire audience that viewed an opportunity or that regularly views the vehicle in which an opportunity is placed. Alternatively, an engagement score may be computed only for the overlap between the content audience for an opportunity and a target audience desired by a brand.

Data sources 140 includes social data which is ingested and stored in pristine storage 415. Social data may include data types such as those listed below in Table 4.

TABLE 4
Example social data sources

| Data Source | Description |
|---|---|
| Social networks/ | Social networks, e.g. |
| social media | FACEBOOK/INSTAGRAM, and |
| | YOUTUBE provide data about |
| | their users. When users opt-in |
| | information such as brands |
| | they like can be reported along |
| | with demographic information. |
| Social network | Services, such as SHAREABLEE, |
| analytics services | provide aggregated and |
| | processed data regarding |
| | audience's social engagement |
| | characteristics. |

An overall Fit score that reflects both an audience score and an engagement score can be computed. This overall score, referred to as a Fit score can be defined using Equation 1, below, as:

Fit(t,o)=f(AS(t,o),ES(t,o)) Equation 1

where t is the target audience for a brand campaign, o in an opportunity, AS(t, o) is the audience score for the opportunity relative to the defined target opportunity, and ES(t,o) is the engagement score for the opportunity relative to the defined target opportunity.

In certain embodiments, the function the engagement score (ES(t,o) acts as a multiplier of the audience score AS(t,o), as illustrated below in Equation 2:

Fit(t,o)=AS(t,o)*g(ES(t,o)) Equation 2

where g(ES(t,o)) is a function of the engagement score ES(t,o).

In other embodiments, ES(t,o), the engagement score acts as an exponential on the audience score, AS(t,o), as shown in Equation 3 below:

Fit(t,o)=AS(t,o)^{g(ES(t,o))} Equation 3

where AS(t,o) is the audience score and g(ES(t,o)) is a function of ES(t,o), the engagement score.

Generally, in Equations 2-3 the engagement score serves to modify the value of the audience score. The underlying logic is that if a share of the target audience views a program or vehicle in which a placement is made, as represented by the audience score, there is potentially a material impact based on the portion of the viewers that then go out and communicate beneficially about the program. Thus, Equations 2 and 3 capture the “network effect” of social media.

FIG. 7 is a flow diagram that illustrates a method for creating personas for use in persona based matching (PBM). At step 710 a buyer uses a user interface, such as that described with reference to FIGS. 3A-D, which enables him/her to define a target audience, or brand persona, that corresponds to a target audience for a media plan or campaign. This typically occurs as part of the process of defining or editing a media plan. In certain embodiments, concurrently with defining the target audience, brand placement system 134 returns a list of existing personas, referred to herein as default personas, that correspond, at least partially, to the target audience. In a preferred embodiment, this step is performed in real-time, i.e. personas are displayed to the buyer as they successively provide additional detail about the target audience.

Next, the buyer associates a persona with the target audience. There are three alternative ways for a buyer to associate a persona with a target audience: (1) at step 712 the buyer can review and search for default, i.e. predefine personas, (2) at step 722 the buyer can select a default persona, clone it, and then define or modify the attributes of the default persona to create a new persona, or (3) at step 720 the buyer can start from scratch and using the buyer interface can create a new persona.

Thus, at step 712, default personas are presented to the buyer. These are provided from a database of personas 714 that enables the user to view and access data from pristine storage 415, which is provided via a schema layer 420 and a UCS layer 425. Next, at step 716, the buyer decides whether to select one of the available default personas or to select a default persona and clone it, i.e. create a new copy that can be used as the basis for a new persona. If the buyer selects a default persona to represent the target audience then the method ends. If the buyer selects to create a clone persona, then at step 722 the selected default persona is cloned. Alternatively, the buyer can select a control to create a new persona and control flows to step 720 where a new persona is created.

At step 724 the buyer can define or modify persona attributes using a user interface such as that described with reference to FIGS. 3A-D. Finally, at step 726 the buyer saves the custom-created persona in persona database 714 and the method ends. Upon conclusion of the method, a persona has been associated with the target audience. The buyer may repeat the method and associate additional personas with the target audience. The audience scoring, engagement scoring and Fit analysis can then be performed to identify available opportunities that match the target audience defined by the buyer.

An overall method 800 for ingesting opportunity data, defining a target audience using personas and then calculating a fit metric between opportunities and the target audience is illustrated in FIG. 8. Method 800 includes 3 asynchronous sub-methods that are typically implemented as independent processes performed by placement service 130. The three sub-methods are illustrated in FIGS. 8A-C.

FIG. 8A illustrates a simplified embodiment of the steps performed to ingest data from data sources 140 and store normalized data in pristine storage 415. This method is described in addition detail in FIG. 4A. Essentially, data from data sources 140 is ingested at step 810. Ingested data is stored in pristine storage 415. This data is then available to brand placement system 134, which performs the processing steps of FIGS. 8A-B.

At step 815 a buyer creates a brand persona, which specifies a target audience for their media plan.

FIG. 8B illustrates a simplified embodiment of the steps performed by a buyer to create a brand persona that specifies a target audience for a placement campaign. At step 815, a buyer uses buyer application 115 to creates a brand persona that defines a target audience for a media plan. As previously discussed a brand persona is a union of the characteristics specified in one or more personas. To create the brand persona, a buyer may select one or more existing personas 820 for inclusion or may create one or more new personas, which are in turn stored as a new persona 820. Persona 820 refers to a library or database of personas stored by content CDS 132. If more than one persona is selected then, in certain embodiments, the buyer can apply a weight to each persona. In certain embodiments, the buyer can apply a weight to individual attributes of a person. The selection of personas and weights are together referred to as a brand persona. A brand persona defines the brand target audience for a media plan or campaign. This step is part of the overall step of defining a brand or product campaign, which may involve other steps such as specifying a name, a duration and a budget for the campaign. The brand persona together with any additional media plan information is stored in database 825 by CDS 132.

FIG. 8C is a flow diagram of a simplified embodiment of a method for generating scores for a brand campaign that measure the fit between a target audience and a set of available placement opportunities. At step 830, an opportunity search is initiated. For example, brand placement system 134 may initiate an opportunity search automatically by as part of the process for specifying a media plan, as described in FIG. 3B. Alternative, a search may be initiated explicitly by a buyer using buyer application 115. The goal of the search is to obtain the “universe” of all available opportunities for placements that fit or match, to some extent, a brand persona or target audience specified in a media plan. While placement campaigns, defined by media plans, have been described herein as pertaining to a particular brand or product, e.g. the introduction of a new motorcycle or beverage, the current method is not so limited and can be used for other types of brand campaigns, such as raising awareness, or improving retention. Further, the approach described by method 800 can be extended to cover campaigns that address multiple products and multiple brands.

At step 835, opportunities that overlap, to some extent, the target audience are identified. The demographic, psychographic and behavioral characteristics of a target audience are evaluated relative to each opportunity to identify opportunities that may be of interest to the target audience. In addition, similar content will be identified and included in the search results based on commonalities such as cast, genre, seasonality, day and time a program airs, brand affinity and other variables.

At step 840 an audience score is calculated for each of the opportunities identified in the preceding step. As previously discussed the audience score is a measure of the degree of overlap between each opportunity and the target audience for a placement campaign.

At step 845, data concerning social media engagement is used to expand the universe of opportunities by identifying other opportunities with which the target audience engages. For example, if persons in the target audience who express sentiment or reaction such as like, love, or interest dislike or anger for a TV show such as RAY DONOVAN also indicate a similar sentiment or reaction to another show, such as TROLL HUNTERS, then TROLL HUNTERS may be added to the list of opportunities. Data such as social media discussion, indications of sentiment such as LIKES, are analyzed to obtain this information.

At step 850 an engagement score is calculated for each of the opportunities identified in the preceding step. As previously discussed the engagement score measures the relative level of engagement with an opportunity by the target audience based on social media data.

At step 855, a Fit score is calculated for each opportunity. As previously discussed, in certain embodiments the Fit score is a function of both the audience score and the engagement score for the opportunity. In other embodiments, only an audience score or an engagement score may be calculated in which case the since score becomes the Fit score.

Finally, at step 860 the search results, which include information about the opportunities identified, and at least a Fit score for each opportunity, are returned. In certain embodiments, a Fit score and one or both of the audience score and the engagement score is returned in addition to the opportunity data. The opportunity information returned by the search typically includes a selection of the data illustrated in FIG. 3B, such as a thumbnail, a name for the opportunity, an indication of the type of media, and other relevant data.

Although not included in this method, the Fit score, audience score and engagement score may also be used to (1) display for the buyer, (2) to order search results, (3) for purposes of reporting, and (4) provide proactive electronic communications such as recommendations, notifications, and alerts.

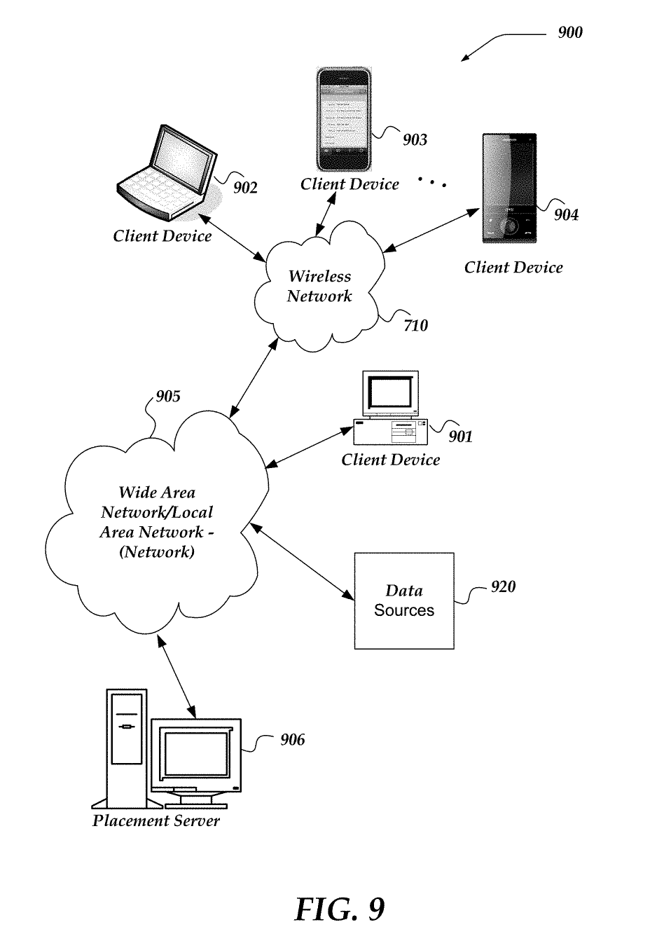

FIG. 9 is a system diagram that shows components of one exemplary environment in which the invention may be practiced. Not all of the components may be required to practice the invention, and variations in the arrangement and types of the components may be made without departing from the spirit or scope of the invention. As shown, system 900 of FIG. 9 includes wide area network (“WAN”)/local area network (“LAN”)−(network) 905, wireless network 910, client devices 901-904, and a placement server 906.

Buyer computer 110 and management computer 120 are embodiments of client devices 901-904 which may connect to either or both of wireless network 910 or network 905. Network 150 is an embodiment of wireless network 910, network 905, or a combination of both. Placement server 906 shows one embodiment, or implementation, of placement service 130. Further, data sources 140 are one embodiment of data sources 920.

Generally, client devices 901-904 include any computing devices that are capable of receiving and sending messages over a network, such as network 905 or wireless network 910. Client devices 901-904 include personal computers, multiprocessor systems, microprocessor-based or programmable consumer electronics, mobile devices such as mobile telephones, smart phones, display pagers, tablet computers, handheld computers, laptop computers, wearable computers, or the like.

A Web-enabled client device can communicate across the Web. It may include a browser application that is configured to receive and to send web pages, web-based messages, or the like. The browser application may send, receive and display graphics, text, multimedia, or the like, employing a network protocol such as Hypertext Transfer Protocol (HTTP), HTTP over SSL (HTTPS), and/or wireless application protocol (WAP). Note that the term HTTP/S is used subsequently to refer to either of HTTP or HTTPS.

Client devices 901-904 may include client application programs that send and receive content to/from other computing devices. Examples of application programs include calendars, browsers and email clients and so forth. Client devices 901-904 may be configured to include an application program that enables a buyer to specify, edit and review a media plan and to view results from a corresponding placement campaign in cooperation with placement server 906. Client devices 901-904 may also be configured to include other application programs used by a media buyer, or management personnel.

Wireless network 910 is configured to couple client devices 902-904 with network 905. Wireless network 910 may include any of a variety of wireless networks that provide a connection for client devices 902-904. Such networks may include mesh networks, wireless LAN (WLAN) networks, cellular networks, or the like. Wireless network 910 may further include network devices such as gateways routers, or the like. In essence, wireless network 910 may include virtually any wireless communication device or mechanism by which enables information to travel between client devices 902-904 and another computing device, network, or the like.

Network 905 is configured to couple placement server 906, and client device 901 with other computing devices, including through wireless network 910 to client devices 902-904. Network 905 may include the Internet in addition to local area networks (LANs), wide area networks (WANs), direct connections, combinations thereof or the like.

Placement server 906 represents one or more network computing devices that are configured to enable a media buyer to interactively specify a media plan, to execute a placement campaign based on the media plan, and to generate results and provide the results to client devices 901-904 for review by the buyer. Placement server 906 is one embodiment of a network device that implements placement service 130.

Devices that may operate as placement server 906 include, but are not limited to personal computers, desktop computers, multiprocessor systems, microprocessor-based or programmable consumer electronics, network PCs, servers, network appliances, and the like.

Although placement server 906 is illustrated as a distinct network device, the invention is not so limited. For example, a plurality of network devices may be configured to perform the functions of placement server 906. One such configuration is a “server farm” that includes multiple server computers operating cooperatively, each performing some of placement server 906 server functions. One embodiment of the software modules that perform placement server 906 server functions is described with reference to FIG. 8 below.

Placement server 906 functions may also be provided by a cloud computing facility in which the services, features and functions ascribed herein to placement server 906 are delivered as a service over a network, such as the Internet, rather than by a specific server or cluster of servers.

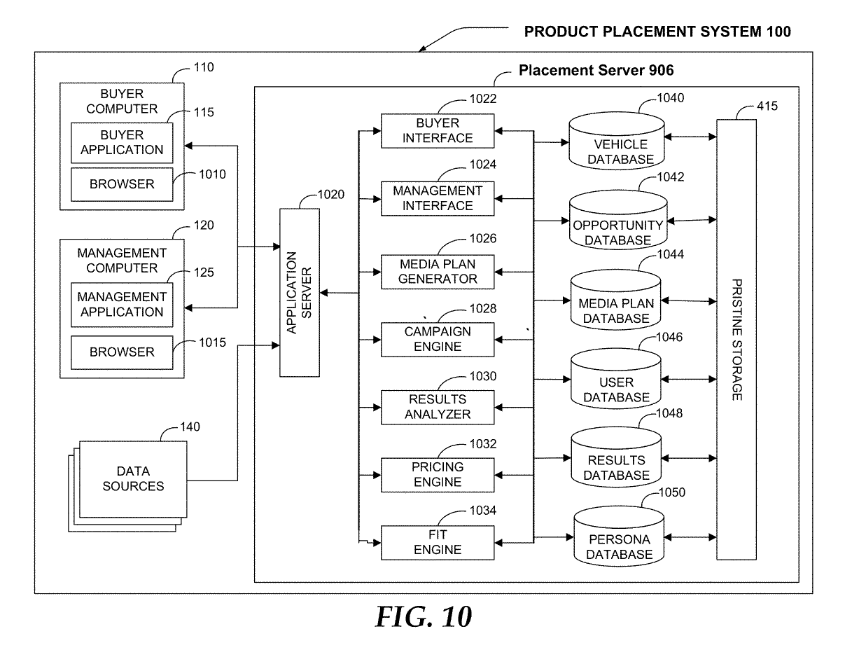

Placement server 906 is capable of running application programs (“applications”). Applications that may be run by placement server 906 include transcoders, database programs, customizable user programs, security applications, encryption programs, VPN programs, web servers, applications servers, account management systems, and so forth. Applications run by placement server 906 may also include a buyer interface, a management interface, a database manager, and other applications and processes such as those described below in conjunction with FIG. 10.

Placement server 906 provides web services which include any of a variety of network services that are configured to provide content, including messages, over a network to another computing device. Thus, web services may include an application server, a web server, a messaging server, a File Transfer Protocol (FTP) server, a database server, a content server, or the like. Web services may provide the content including messages over the network using any of a variety of formats, including, but not limited to WAP, HDML, WML, SGML, HTML, XML, cHTML, xHTML, JSON, REST, SOAP or the like. Web services may also include server-side scripting languages such as PHP, Python, and Java servlets. Web services may also include the server side of the Ajax web development method that enables a server to asynchronously respond to Ajax requests.

Placement server 906 includes a computer processor (CPU) and nonvolatile data storage for storing program code and data. Data storage may include virtually any mechanism usable for storing and managing data, including but not limited to a file, a folder, a document, a web page or an application, such as a database, digital media including digital images and digital video clips, and the like.

Data storage may further include a plurality of different data stores. For example, data storage may represent an opportunity database, a user database and other databases such as those described below in conjunction with FIG. 10. Further, data storage may also include network storage or cloud storage in which the physical storage media is accessed across a network.

Data sources 920 are accessed across network 905/910 from placement server 906. Typically, data sources 920 is accessed using Web services as previously described. Additionally, data sources 920 may provide data through a cloud storage facility that is accessed using protocols such as HTTP/S and FTP.

FIG. 10 is block diagram of the exemplary software modules of buyer computer 110, management computer 120 and placement server 906.

As discussed above with reference to FIG. 1, a buyer interacts with buyer computer 110 via buyer application 115. In a preferred embodiment, buyer application 115 is a Web application, which is written using standard Web programming languages such as HTML, JAVASCRIPT, and JAVA, and is executed by a browser 1010 that runs on buyer computer 110.

Browser 1010 is typically a standard, commercially available, browser such as MOZILLA FIREFOX, MICROSOFT INTERNET EXPLORER, or GOOGLE CHROME. Alternatively, it may also be a client application configured to receive and display graphics, text, multimedia, and the like, across a network.

In one embodiment, when a buyer interacts with placement service 130 using buyer application 115, placement service 130 downloads web pages in HTML format to browser 1010 for viewing and interactive use. To perform some of the advanced client-side interactive functions the web pages may include client-side scripting instructions from a client-side scripting language. Typically, such client-side scripting instructions are embedded in HTML web pages and are interpreted or executed by a client-side scripting engine to perform functions not available through HTML commands such as advanced graphics, database access, and computations.

Examples of client-side scripting languages include JAVASCRIPT® from ORACLE CORPORATION of Redwood Shores, Calif., the Java open source programming language, ACTIVEX® from the MICROSOFT CORPORATION of Redmond, Wash.

In one embodiment, browser 1010 issues HTTP/S requests to and receives HTTP/S responses from an application server 1020 running in placement service 130.

Application server 1020 receives the HTTP/S requests and invokes the appropriate placement server 906 service to process the request. Application server 1020 may be a commercially available application server that includes a web server that accepts and processes HTTP/S requests transmits HTTP/S responses back along with optional data contents, which may be web pages such as HTML documents and linked objects (images, or the like). In addition, browser 1010 may use Ajax to issue requests for XML or JSON-coded information that is delivered asynchronously by application server 1020. Henceforth, the term request message will refer to a message sent by browser 1010 using HTTP/S, Ajax or other client-server communications method to placement server 906. And a response message will refer to a message sent in response, typically using the same communications method, by application server 1020 running in placement server 906.

Application server 1020 establishes and manages buyer and manager sessions. Typically, application server 1020 assigns each session a unique session id. A session lasts from the time a buyer or manager logs in, or accesses placement service 130, until the time the buyer or manager logs out or stops interacting with placement service 130 for a specified period of time. In addition, application server 1020 typically manages server applications and provides database connectivity.

Upon request by browser 1010, application server 1020 downloads to buyer computer 110 or management computer 120 the HTML, JAVASCRIPT and other browser-executable code that make up buyer application 115 or management application 125, respectively.

In one embodiment, placement server 906 includes the following modules: a buyer interface 1022, a management interface 1024, a media plan generator 1026, a campaign engine 1028, a results analyzer 1030 and a pricing engine 1032. Placement service 130 further includes pristine storage 415 and five operational databases: a vehicle database 1040, an opportunity database 1042, a media plan database 1044, a user database 1046, a results database 1048 and a persona database 1050. It may be appreciated that each of the abovementioned databases may be implemented as one or more computer files spread across one or more physical storage mechanisms. In one embodiment, each of the abovementioned databases is implemented as one or more relational databases and is accessed using the structured query language (SQL). In other embodiments, a non-relational database may be used.

Pristine storage 415 receives ingested data from data sources 140 and stores the data in normalized formats. Pristine storage 415 is updated periodically. In certain embodiments, pristine storage 415 is implemented as a separate server with data storage and a processor. In other embodiments, pristine storage 415 is implemented as a third party cloud service, such as AMAZON WEB SERVICES, which is accessible across a network.

Buyer interface 1022, management interface 1024, media plan generator 1026, campaign generator 1028, results analyzer 1030, pricing engine 1032, and audience fit engine 1034 may each include, or may share the use of, a commercial database management system (DBMS) to access and search for data and objects that reside in the database. In certain embodiments, the DBMS is a relational DBMS (RDBMS) such as POSTGRESQL, an open source database provided by the POSTGRESQL GLOBAL DEVELOPMENT GROUP, ORACLE® from the Oracle Corporation, SQL SERVER from the Microsoft Corporation, or the like. In other embodiments, a non-relational database, such as MONGODB, may be used.

Buyer interface 1022 responds to requests from buyer application 115, i.e. it performs the back-end server processing. Buyer interface enables a media buyer to log in to placement service 130, interactively create a media plan and view forecasts and results from the corresponding placement campaign. Buyer interface 1022 provides buyer interface screens and data elements to buyer computer 110 and receives data from buyer computer 110. In one embodiment, upon request management interface 722 transmits web pages, scripts and other elements used by buyer application 115 to interactively display buyer interfaces 2A-H and 4A-D to buyer computer 110 for use by buyer application 115.

Management interface 1024 responds to requests from management application 125, i.e. it performs the server processing corresponding to the client processing performed by management application 125. Management interface 1024 enables staff persons to log in to placement service 130, review, add, edit and delete vehicles, opportunities, media plans, production and placement details, and buyer records stored in a user database. In one embodiment, upon request management interface 1024 transmits web pages, scripts and other elements used by management application 125 to interactively display management interfaces to buyer computer 110 for use by management application 125.

Media plan generator 1026 generates lists of opportunities, consistent with a media plan, for review, filtering and selection by a media buyer using buyer application 115. In some embodiments, media plan generator 1026 calculates vehicle power and placement quality of vehicles. Media plan generator 1026 stores media plans in media plan database 844.

Campaign engine 1028 executes media plans stored in media plan database 1044 by purchasing or causing to be purchased placements as indicated in a media plan. Campaign engine 1028 maintains an updated status of placements during a placement campaign.

Results analyzer 1030 obtains campaign results data from data sources 140 via pristine storage 415 and generates prices, impressions, and other results data. Results analyzer 1030 stores results data in results database 1048. Results analyzer 1030 relies on pricing engine 1032 to perform results forecasts such as price and impressions and to determine media values and, in some embodiments, market values of placements.

Pricing engine 1032 forecasts results and determines results of placement campaigns. Pricing engine 832 stores results data in results database 1048.

Audience fit engine 1034 calculates the audience fit between opportunities and brand persona established by a buyer for a media plan. Audience fit results are stored along with the opportunities in opportunity database 1042.

In the discussion hereinbelow concerning databases it may be appreciated by one skilled in the art that each database may be implemented as one or more database files, alternatively two or more of the databases may be implemented as a single database file. Further the term database may refer to a relational database file that is accessed by a relational database manager, non-relational database manager, as a B-tree, R-tree, spreadsheet, flat file, comma separated value (CSV), or as any other type of suitable data structure stored within one or more computer files.

Vehicle database 1040 stores records for each vehicle in which a placement may be made. The records typically include metadata that describe properties of the vehicle such as the producer or director, artists, owner, contact information, and vehicle power.

Opportunity database 1042 stores records for each placement opportunity. The records typically include metadata that describe properties of the opportunity such as the vehicle in which the opportunity occurs, the start and end point, the duration, a description of the scene, which actors are present, and the like. Opportunity records may also store audience fit data relative to specific brand persona.

Media plan database 1044 stores records for each media plan prepared or being prepared by a buyer. The records typically include metadata that describe properties of the media plan such as descriptive information provided by the buyer using buyer interface 200, target channel mix, opportunities selected for inclusion and exclusion, filters and other information captured using buyer interfaces 210 and 220, and opportunities to be included in the media plan.

User database 1046 stores a record for each buyer, management staff or other user of placement service 130. Each user record includes information such as name and contact information, username and password. Buyer records may include information about buyer preferences.

Results database 1048 stores results from placement campaigns, typically generated by results analyzer 1030 and pricing engine 1032. Results database may include price information such as market rates for conventional advertising, and price tables to be used for forecasting placement prices. Results database 1032 may also include historical information and information obtained from data sources 140.

Persona database 1050 stores persona created by a management user according to the method described with reference to FIG. 7.

The above specification, examples, and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for generating scores for a brand campaign that measure the fit between a target audience and a set of available placement opportunities, comprising:
enabling a user, using a client computer, to define a first persona wherein a persona is a visual representation of a fictitious individual that represents a target audience for a placement campaign, wherein a placement is a visible display of a product that is placed in a media vehicle;
storing by a placement server, the persona;
ingesting data that characterizes opportunities for placements in media vehicles;
identifying one or more opportunities whose characteristics overlap the characteristics of the target audience;
calculating an audience score that measures the relative overlap of the identified opportunities with the target audience;
identifying one or more opportunities with which the target audience engages using social media;
calculating an engagement score that measures the relative level of engagement with the identified opportunities by the target audience;
for each opportunity, calculating a Fit score, wherein a Fit score is a function of both the audience score and the engagement score for the opportunity.

2. The method of claim 1 further comprising:
enabling the user to define a second persona; and
wherein the target audience is a union of the target audiences represented by the first and second persona.

3. The method of claim 2 further comprising:
enabling the user to specify weights for each of the first and second persona; and
wherein the target audience represents the weighted union of the first and second personas.

4. The method of claim 1 wherein the media vehicles in which placements may be made as part of the placement campaign include at least one of the group consisting of television program, film, social media network, web advertisement, video, and song.

5. The method of claim 1 further comprising:
performing a search of all opportunities by the placement server;
returning the results of the search together with the Fit scores for those opportunities included in the search results to the client computer for display to the user.

6. The method of claim 1 wherein a persona specifies demographic and psychrographic characteristics of a target audience.

7. The method of claim 6 wherein at least one demographic characteristic is selected from the group consisting of age, gender, and ethnicity; and at least one psychrographic characteristic is selected from the group consisting of personality traits, values, attitude and interests.

8. The method of claim 1 wherein the Fit score for an opportunity is calculated as
Fit(t,o)=AS(t,o)*g(ES(t,o))
where AS(t, o) is the audience score for target audience t and opportunity o, ES(t, o) is the audience score for target audience t and opportunity o, and g(ES(t, o) is a function of the engagement score ES(t, o).

9. The method of claim 1 wherein the Fit score for an opportunity is calculated as
Fit(t,o)=AS(t,o)^{g(ES(t,o))}
where AS(t, o) is the audience score for target audience t and opportunity o, ES(t, o) is the audience score for target audience t and opportunity o, and g(ES(t, o) is a function of the engagement score ES(t, o).

10. The method of claim 1 wherein enabling a user to define a first persona comprises:
receiving a selection of predefined personas from the placement server; and
selecting one of the predefined personas.

11. The method of claim 1 wherein enabling a user to define a first persona comprises:
receiving a selection of predefined personas from the placement server;
selecting one of the predefined personas to clone; and
modifying at least one of the attributes of the cloned persona.

12. A server computer, comprising:
a processor;
a communication interface in communication with the processor;
a data storage for storing a database of placement opportunities wherein a placement is a visible display of a product that is placed in a media vehicle;
a memory in communication with the processor for storing instructions, which when executed by the processor, cause the server:
to receive from a user using a client computer, a specification of a first persona, wherein a persona is a visual representation of a fictitious individual that represents a target audience for a placement campaign;
storing the specification of the first persona;
to ingest data that characterizes opportunities for placements in media vehicles;
to identify one or more opportunities whose characteristics overlap the characteristics of the target audience;
to calculate an audience score that measures the relative overlap of the identified opportunities with the target audience;
to identify one or more opportunities with which the target audience engages using social media;
to calculate an engagement score that measures the relative level of engagement with the identified opportunities by the target audience;
for each opportunity, to calculate a Fit score, wherein a Fit score is a function of both the audience score and the engagement score for the opportunity.

13. The server computer of claim 12 wherein the instructions, when executed by the processor, further cause the server:
to receive a specification of a second persona; and
wherein the target audience is a union of the target audiences represented by the first and second persona.

14. The server computer of claim 13 wherein the instructions, when executed by the processor, further cause the server:
to receive weights specified by the user that correspond to the first and second persona; and
wherein the target audience represents the weighted union of the first and second personas.

15. The server computer claim 12 wherein the media vehicles in which placements may be made as part of the placement campaign include at least one of the group consisting of television program, film, social media network, web advertisement, video, and song.

16. The server computer of claim 12 wherein the instructions, when executed by the processor, further cause the server:
to perform a search of all opportunities by the placement server;
to return the results of the search together with the Fit scores for those opportunities included in the search results to the client computer for display to the user.

17. The server computer of claim 12 wherein a persona specifies demographic and psychrographic characteristics of a target audience.

18. The server computer of claim 17 wherein at least one demographic characteristic is selected from the group consisting of age, gender, and ethnicity; and at least one psychrographic characteristic is selected from the group consisting of personality traits, values, attitude and interests.

19. The server computer of claim 12 wherein the Fit score for an opportunity is calculated as
Fit(t,o)=AS(t,o)*g(ES(t,o))
where AS(t, o) is the audience score for target audience t and opportunity o, ES(t, o) is the audience score for target audience t and opportunity o, and g(ES(t, o) is a function of the engagement score ES(t, o).

20. The server computer of claim 12 wherein the Fit score for an opportunity is calculated as
Fit(t,o)=AS(t,o)^{g(ES(t,o))}
where AS(t, o) is the audience score for target audience t and opportunity o, ES(t, o) is the audience score for target audience t and opportunity o, and g(ES(t, o) is a function of the engagement score ES(t, o).

21. The server computer of claim 12 wherein the instructions, when executed by the processor, further cause the server:
to provide a selection of predefined personas to the client computer; and
receiving a selection one of the predefined personas.

22. The server computer of claim 12 wherein the instructions, when executed by the processor, further cause the server:
to provide a selection of predefined personas to the client computer;
to provide a selection of attributes that can be associated with a persona; and
receiving a new persona along with a set of attributes to associate with the new persona.
